(19) United States
(12) Patent Application Publication
(10) Pub. No.: US 2024/0076161 A1
(43) Pub. Date: Mar. 7, 2024

(54) PEOPLE COUNTING DEVICE FOR AN ELEVATOR

(71) Applicant: CEDES AG, Landquart (CH)

(72) Inventor: Jianyong WEN, Sargans (CH)

(73) Assignee: CEDES AG, Landquart (CH)

(21) Appl. No.: 18/453,542

(22) Filed: Aug. 22, 2023

(30) Foreign Application Priority Data
Sep. 2, 2022 (EP) 22 193 739.4

(51) Int. Cl. B66B 5/00; B66B 3/00

(52) U.S. Cl. CPC B66B 5/0012; B66B 3/002

(57) ABSTRACT

People counting device for an elevator car for determining a person entering or leaving the car, having a presence sensor at the entrance of the car for detecting the presence of a person in the region of the entrance or the passage of a person through the entrance and for outputting a detection signal in the event of presence or passage, having an accelerometer on the car, for detecting the vertical acceleration of the car and for outputting positive and negative acceleration values in relation to the upwards direction of movement of the car, and having an evaluation device that is designed, upon receipt of the detection signal, to receive a series of current acceleration values for a certain duration and to analyze whether one of the acceleration values or the motion profile resulting therefrom exceeds an upper threshold value or falls below a lower threshold value.

This application claims the benefit under 35 USC § 119(a)-(d) of European Application No. 22 193 739.4 filed Sep. 2, 2022, the entirety of which is incorporated herein by reference.

### FIELD OF THE INVENTION

The present invention relates to a people counting device for an elevator.

### BACKGROUND OF THE INVENTION

The prior art discloses people counting devices that use video analysis.

### SUMMARY OF THE INVENTION

The object of the present invention is to provide an improved people counting device.

The people counting device according to the present invention is a people counting device, for an elevator having an elevator car having an entrance, for determining a person entering or leaving an elevator car, having a presence sensor at the entrance of the elevator car for detecting the presence of a person in the region of the entrance or the passage of a person through the entrance and for outputting a detection signal in the event of presence or passage, having an accelerometer on the elevator car, for detecting the vertical acceleration of the elevator car and for outputting positive and negative acceleration values in relation to the upwards direction of movement of the elevator car, and having an evaluation device that is designed, upon receipt of the detection signal, to receive a series of current acceleration values for a certain duration and to analyze whether one of the acceleration values or the motion profile resulting therefrom exceeds an upper threshold value or falls below a lower threshold value and to output or to process a signal for a person entering the elevator car if the lower threshold value has been fallen below and to output or to process a signal for a person leaving the elevator car if the upper threshold value has been exceeded.

This may provide the advantage that an existing sensor may be used. This may provide the advantage of saving costs.

Entering means that a person moves from the space in front of the elevator car through the passage of the open elevator doors into the elevator car. Leaving means that a person moves from the inside of the elevator car through the passage of the open elevator doors into the space in front of the elevator car. Upon receipt means at the beginning of reception. The detection signal, like the certain duration, always occurs when the elevator car stops at a stop and when the elevator car doors are open. Positive acceleration values correspond to an upwards acceleration of the elevator car, that is to say in the direction of the shaft head. Negative acceleration values correspond to a downwards acceleration of the elevator car, that is to say in the direction of the shaft pit. Preferably, the upper threshold value is a positive acceleration value. Preferably, the lower threshold value is a negative acceleration value.

Preferably, the evaluation device is designed to sum the signals for entering to form a value and to subtract the signals for leaving from the value and to output the value for the number of people in the elevator car and, in particular, to set the value to zero after a certain duration of stopping without a signal.

This may provide the advantage that more extensive information is available for the elevator car.

Preferably, the certain duration is between 0.05 and 1 second, in particular between 0.1 and 0.5 seconds, in particular between 0.2 and 0.3 seconds.

This may provide the advantage of being particularly reliable.

Preferably, the upper threshold value is between 0.001 g and 0.003 g in the case of an acceleration or between 0.01 mm and 0.05 mm in the case of a rise, and/or the lower threshold value is between −0.001 g and −0.003 g in the case of an acceleration or between −0.01 mm and −0.05 mm in the case of a drop.

This may provide the advantage of being particularly reliable.

Preferably, the acceleration sensor is attached to the presence sensor. Preferably, the presence sensor and the acceleration sensor have the same carrier. Preferably, the presence sensor and the acceleration sensor have the same housing. Preferably, the evaluation device is integrated in the presence sensor.

This may provide the advantage of being particularly easy to install. This may provide the advantage of saving costs. This may provide the advantage of taking up little space.

Preferably, the presence sensor is a light curtain or a light barrier.

This may provide the advantage that an existing sensor may be used. This may provide the advantage of saving costs.

Preferably, the evaluation device has a device for wireless radio transmission.

This may provide the advantage that remote monitoring is possible.

Further features of the present invention are indicated in the drawings.

The advantages mentioned in each case may also be achieved for combinations of features in connection with which they are not mentioned.

### BRIEF DESCRIPTION OF THE DRAWINGS

Exemplary embodiments of the present invention are illustrated in the drawings and are explained in more detail below. The same reference signs in the individual figures in this case denote elements that correspond to one another.

FIG. 1 shows an acceleration diagram for entering the elevator car; and

FIG. 2 shows an acceleration diagram for leaving the elevator car.

### DETAILED DESCRIPTION OF THE INVENTION

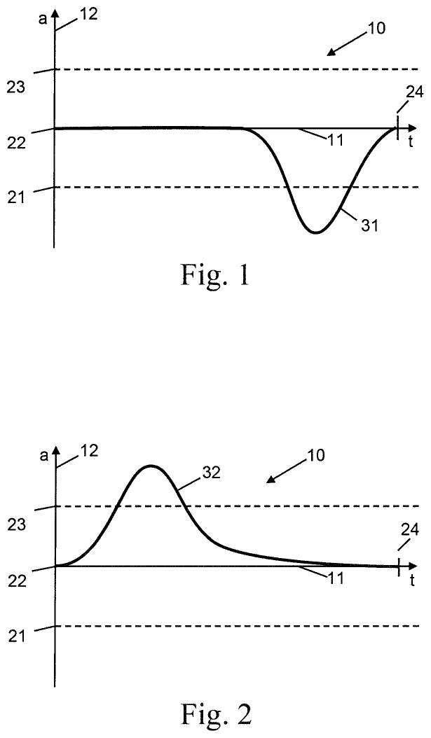

FIG. 1 shows an acceleration diagram 10 for a person entering the elevator car. The X-axis shows the course of time 11 and the Y-axis shows the acceleration 12. A lower threshold value 21 for the acceleration shows a negative acceleration, that is to say a downwards acceleration of the elevator car. The point of intersection of the time axis 11 and the acceleration axis 12 is the location of the zero point 22 of the acceleration, that is to say no acceleration of the elevator car. An upper threshold value 23 for the acceleration shows a positive acceleration, that is to say an upwards acceleration of the elevator car. The signal time is the time 0 at the point of intersection of the time axis 11 and the acceleration axis 12.

A light barrier is installed on the doors of the elevator car and monitors the entrance of the elevator car. An accelerometer for measuring the vertical acceleration and an evaluation device are integrated into the housing of the light barrier.

At the time 0, a person interrupts the light barrier at the entrance of the elevator car in order to enter the elevator car. The light barrier transmits a detection signal to the evaluation device. The evaluation device receives the detection signal. In the event of a sustained detection signal, only the beginning of the detection signal is relevant. The beginning of receipt of the detection signal is the time 0. At the beginning of receipt of the detection signal, the elevator controller starts a timer until a certain duration 24 elapses. During the certain duration, the evaluation devices receive values from the accelerometer, values for the acceleration of the elevator car, which exhibit the profile of the acceleration curve 31. The evaluation device analyzes the acceleration values and recognizes that at least one acceleration value falls below the lower threshold value 21, and transmits a signal for a person entering the elevator car to a server via a radio device.

FIG. 2 shows an acceleration diagram 10 for a person leaving the elevator car according to FIG. 1.

At the time 0, a person interrupts the light barrier at the entrance of the elevator car in order to leave the elevator car. The light barrier transmits a detection signal to the evaluation device. The evaluation device receives the detection signal. In the event of a sustained detection signal, only the beginning of the detection signal is relevant. The beginning of receipt of the detection signal is the time 0. At the beginning of receipt of the detection signal, the elevator controller starts a timer until a certain duration 24 elapses. During the certain duration, the evaluation devices receive values from the accelerometer, values for the acceleration of the elevator car, which exhibit the profile of the acceleration curve 32. The evaluation device analyzes the acceleration values and recognizes that at least one acceleration value exceeds the upper threshold value 23, and transmits a signal for a person leaving the elevator car to a server via a radio device.

### LIST OF REFERENCE SIGNS

10 Acceleration diagram
11 Time axis
12 Acceleration axis
21 Lower threshold value of the acceleration
22 Zero point of the acceleration
23 Upper threshold value of the acceleration
24 End of the certain duration
31 Acceleration curve for entering
32 Acceleration curve for leaving

1. A people counting device,
for an elevator having an elevator car having an entrance,
for determining a person entering or leaving an elevator car,
having a presence sensor at the entrance of the elevator car for detecting the presence of a person in the region of the entrance or the passage of a person through the entrance and for outputting a detection signal in the event of presence or passage,
having an accelerometer on the elevator car, for detecting the vertical acceleration of the elevator car and for outputting positive and negative acceleration values in relation to the upwards direction of movement of the elevator car, and
having an evaluation device that is designed, upon receipt of the detection signal, to receive a series of current acceleration values for a certain duration and to analyze whether one of the acceleration values or the motion profile resulting therefrom exceeds an upper threshold value or falls below a lower threshold value and to output or to process a signal for a person entering the elevator car if the lower threshold value has been fallen below and to output or to process a signal for a person leaving the elevator car if the upper threshold value has been exceeded.

2. The people counting device according to claim 1, wherein the evaluation device is designed
to sum the signals for entering to form a value and
to subtract the signals for leaving from the value and
to output the value for the number of people in the elevator car
and, in particular, to set the value to zero after a certain duration of stopping without a signal.

3. The people counting device according to claim 1, wherein the certain duration is between 0.05 and 1 second, in particular between 0.1 and 0.5 seconds, in particular between 0.2 and 0.3 seconds.

4. The people counting device according to claim 1, wherein
the upper threshold value is between 0.001 g and 0.003 g in the case of an acceleration or between 0.01 mm and 0.05 mm in the case of a rise, and/or
the lower threshold value is between −0.001 g and −0.003 g in the case of an acceleration or between −0.01 mm and −0.05 mm in the case of a drop.

5. The people counting device according to claim 1, wherein
the acceleration sensor is attached to the presence sensor, and
the presence sensor and the acceleration sensor have the same carrier and the same housing, and
the evaluation device is integrated in the presence sensor.

6. The people counting device according to claim 1, wherein the presence sensor is a light curtain or a light barrier.

7. The people counting device according to claim 1, wherein the evaluation device has a device for wireless radio transmission.
